(19) United States
(12) Patent Application Publication
(10) Pub. No.: US 2009/0056765 A1
(43) Pub. Date: Mar. 5, 2009

(54) SINGLE TYPE SUBSTRATE TREATING APPARATUS AND CLEANING METHOD THEREOF

(75) Inventors: Chung-Sic CHOI, Seoul (KR); Yong-Ju JANG, Chungcheongnam-do (KR)

Correspondence Address: CARTER, DELUCA, FARRELL & SCHMIDT, LLP, 445 BROAD HOLLOW ROAD, SUITE 420, MELVILLE, NY, 11747, US

(73) Assignee: SEMES CO., LTD., Chungcheongnam-do (KR)

(21) Appl. No.: 12/200,203

(22) Filed: Aug. 28, 2008

(30) Foreign Application Priority Data
Aug. 29, 2007 (KR) 2007-86907

(51) Int. Cl. B08B 3/02

(52) U.S. Cl. 134/33; 134/104.1; 134/95.3; 134/34

(57) ABSTRACT

Provided is a single type substrate treating apparatus and a cleaning method the substrate treating apparatus. A cleaning process is periodically performed on a substrate support member after a series of repeated substrate treating processes is performed to remove contaminants remaining on the substrate support member and minimize thermal deformation of the substrate support member due to a high temperature chemical solution.

### CROSS-REFERENCE TO RELATED APPLICATIONS

This U.S. non-provisional patent application claims priority under 35 U.S.C. §119 of Korean Patent Application No. 10-2007-0086907, filed on Aug. 29, 2007, the entire contents of which are hereby incorporated by reference.

### BACKGROUND OF THE INVENTION

The present invention disclosed herein relates to a substrate treating apparatus and method, and more particularly, to a single type substrate treating apparatus for cleaning a substrate and a cleaning method thereof.

With the tendency toward high density, high integration, and high performance of semiconductor devices, micronization of circuit patterns is being rapidly progressed. As a result, pollution materials such as particles, organic contaminants, and metal impurities have more effects on device characteristics and product yield. Hence, a cleaning process for removing the various pollution materials attached to a surface of the substrate is considered as an important issue in a semiconductor manufacturing process. The cleaning process is performed on the substrate before and after each unit process.

Cleaning methods used in the typical semiconductor manufacturing process are largely divided into a dry cleaning method and a wet cleaning method. The wet cleaning method is divided into a bath type method and a spin type method. In the bath type method, substrates are dipped into a chemical solution to remove pollution materials using chemical dissolution. In the spin type method, the chemical solution is supplied to the substrate mounted on rotating spin chucks to remove the pollution materials.

Furthermore, the substrate is fixed to chuck members capable of processing a single substrate. The chemical solution or deionized water is sprayed onto the rotating substrate through a spray nozzle to spread the chemical solution or the deionized water on an entire surface of the substrate due to a centrifugal force, thereby cleaning the substrate. Thereafter, the substrate is dried using a drying gas.

### SUMMARY OF THE INVENTION

The present invention provides a single type substrate treating apparatus that can remove pollution materials on a substrate support member supporting a substrate and a cleaning method thereof.

The present invention also provides a single type substrate treating apparatus that can minimize thermal deformation of a substrate support member and a cleaning method thereof.

Embodiments of the present invention provide single type substrate treating apparatuses including a substrate support member supporting a substrate; and a cleaning solution supply unit spraying a cleaning solution onto the substrate support member so as to remove pollution materials remaining on the substrate support member.

In some embodiments, the cleaning solution supply unit may be disposed in a nozzle body disposed on the substrate support member, and may include a nozzle having an end inserted into a cleaning solution supply line formed inside the nozzle body and spraying the cleaning solution onto the substrate support member.

In other embodiments, the single type substrate treating apparatus may further include a rotation driver rotating the substrate support member.

In other embodiments of the present invention, single type substrate treating apparatuses includes a rotatable substrate support member supporting a substrate in which is spaced upwardly from the substrate support member; a chemical solution supply unit spraying a chemical solution onto a bottom surface of the substrate; and a cleaning solution supply unit spraying a cleaning solution onto the substrate support member so as to remove the chemical solution remaining on the substrate support member after a substrate treating process using the chemical solution is performed.

In some embodiments, the chemical solution supply unit and the cleaning solution supply unit may be disposed in a nozzle body disposed on the substrate support member.

In other embodiments, the cleaning solution supply unit may include a nozzle having an end inserted into a cleaning solution supply line formed inside the nozzle body and spraying the cleaning solution onto the substrate support member.

In still other embodiments, the nozzle may be perpendicular to a top surface of the substrate support member, and a first passage and a second passage may be formed in the nozzle, the first passage being disposed along a longitudinal direction of the nozzle, and the second passage communicating the first passage and being parallel to the top surface of the substrate support member.

In even other embodiments, the nozzle may be perpendicular to a top surface of the substrate support member, and a first passage and a second passage may be formed in the nozzle, the first passage being disposed along a longitudinal direction of the nozzle, and the second passage communicating the first passage and being inclined downwardly toward the top surface of the substrate support member.

In yet other embodiments, the cleaning solution supply unit may be provided with a first passage and a second passage which are formed inside the nozzle body, the first passage being perpendicular to the top surface of the substrate support member, and the second passage communicating the first passage and being parallel to the top surface of the substrate support member.

In further embodiments, the cleaning solution supply unit may be provided with a first passage and a second passage which are formed inside the nozzle body, the first passage being perpendicular to the top surface of the substrate support member, and the second passage communicating the first passage and being inclined downwardly toward the top surface of the substrate support member.

In still further embodiments, the second passage may have an end at which a chemical solution outlet port having a hole shape is defined.

In even further embodiments, the second passage may have an end at which a chemical solution outlet port having a slit shape is defined.

In yet further embodiments, the single type substrate treating apparatus may further include a chemical solution supply line supplying the chemical solution to the chemical solution supply unit; and a heater disposed at the chemical solution supply line and heating the chemical solution supplied from the chemical solution supply unit at a process temperature.

In yet further embodiments, the cleaning solution may include room temperature deionized water.

In still other embodiments of the present invention, cleaning methods of a substrate treating apparatus include spraying a chemical solution onto a bottom surface of a substrate supported and spaced upwardly by/from a substrate support member to treat the substrate; and spraying a cleaning solution onto a top surface of the substrate support member to remove the chemical solution remaining on the substrate support member.

In some embodiments, the substrate support member may be rotated.

In other embodiments, a temperature of the chemical solution may be relatively higher than that of the cleaning solution.

In still other embodiments, the chemical solution may include a mixture of ammonium hydroxide(NH₄OH), hydrogen peroxide(H₂O₂), and hydrogen oxide(H₂O).

In even other embodiments, the cleaning solution may include room temperature deionized water.

In yet other embodiments, the chemical solution remaining on the substrate support member may be removed after a series of chemical solution treating processes is sequentially performed on a plurality of substrates.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a view of a single type substrate treating apparatus according to the present invention;

FIG. 2 is a plan view of a nozzle body of FIG. 1;

FIG. 3 is a cross-sectional view taken along line A-A′ of FIG. 2;

FIG. 4 is a cross-sectional view illustrating another example of a cleaning solution nozzle of FIG. 3;

FIGS. 5A and 5B are views of an outlet port of a cleaning solution nozzle;

FIG. 6 is a plan view illustrating another example of a nozzle body;

FIGS. 7 and 8 are cross-sectional views taken along line B-B′ of FIG. 6;

FIG. 9 is a view illustrating another example of a single type substrate treating apparatus according to the present invention;

FIGS. 10A through 10F are views illustrating an operation of a single type substrate treating apparatus according to the present invention; and

FIG. 11 is a view illustrating a cleaning process of a substrate support member.

### DETAILED DESCRIPTION OF PREFERRED EMBODIMENTS

Preferred embodiments of the present invention will be described below in more detail with reference to the accompanying drawings. It is noted that the appending drawings illustrating preferred embodiments and descriptions thereof should be referred adequately to appreciate the advantages in every aspect of the operation of inventive devices and the purposes accomplished by the implementation of the present invention. It is also noted that like reference numerals denote like elements in appreciating the drawings. Moreover, detailed descriptions related to well-known functions or configurations will be ruled out in order not to unnecessarily obscure subject matters of the present invention.

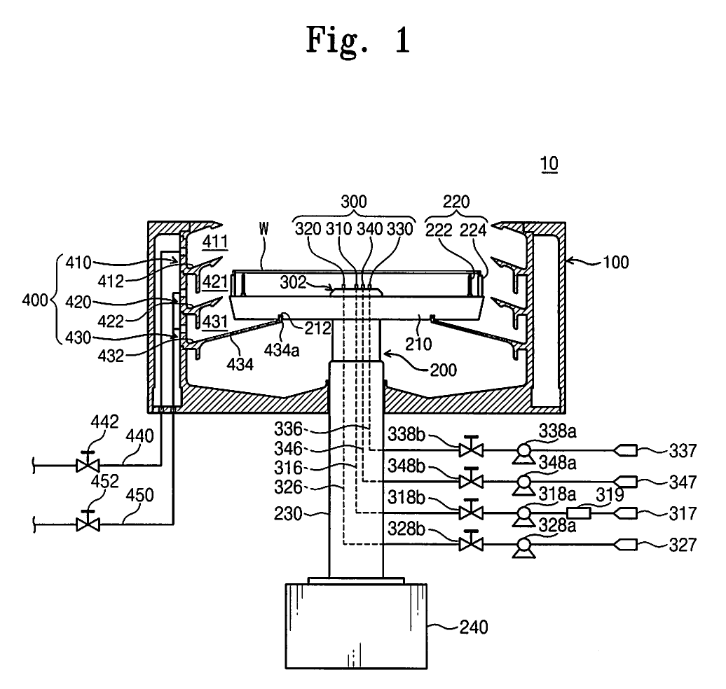

FIG. 1 is a view of a single type substrate treating apparatus according to the present invention.

Referring to FIG. 1, a single type substrate treating apparatus 10 includes a housing 100, a substrate support member 200, a treating fluid supply member 300, and a collection member 400.

The housing 100 provides a space for performing a substrate treating process. The housing 100 has a cylindrical shape which opens upwardly. An opened upper portion of the housing 100 is used as a substrate entrance for loading and unloading a substrate W on/from the substrate support member 200.

The substrate treating process performed within the housing 100 includes a chemical solution treating process, a rinsing process, and a drying process. The chemical solution treating process is a process in which a chemical solution is supplied to the substrate W to etch or separate contaminants remaining on the substrate W. The rinsing process is a process in which a rinse solution is supplied to the chemical solution-treated substrate W to remove the etched or separated contaminants on the substrate W. The drying process is a process in which the rinse solution is removed on the substrate W, and then the substrate W is dried. The chemical solution treating process, the rinsing process, and the drying process are repeatedly performed on a plurality of substrates W sequentially provided in the housing 100. When the processes are repeatedly performed, pollution materials such as a remaining chemical solution and fume produced from the chemical solution may be generated on the substrate support member 200. A cleaning process for cleaning the substrate support member 200 may be additionally performed in the housing 100 in order to periodically remove the pollution materials on the substrate support member 200.

The substrate support member 200 is disposed inside the housing 100. The substrate support member 200 supports the substrate W and is rotated by a driver 240 to be described later. The substrate support member 200 includes a support plate 210 having a top surface of a circular shape. A pin member 220 supporting the substrate W is disposed on the top surface of the support plate 210. The pin member includes a plurality of support pins 222 and a plurality of chucking pins 224. The support pins 222 are disposed on an edge portion of the top surface of the support plate 210. The support pins 222 are disposed in a predetermined arrangement and are spaced from each other by a predetermined distance. The support pins 222 protrude upwardly from the support plate 210. The support pins 222 support a bottom surface of the substrate W while the substrate W is spaced upwardly from the support plate 210 by a predetermined distance. The chucking pins 224 are disposed outside the support pins 222, respectively. The chucking pins 224 protrude upwardly from the support plate 210. The chucking pins 224 align the substrate W supported by the plurality of support pins 222 such that the substrate W is placed at a proper position on the support plate 210. The chucking pins 224 are in contact with a side of the substrate W to prevent the substrate W from being separated from the proper position.

A support shaft 230 supporting the support plate 210 is connected to a lower portion of the support plate 210. The support shaft 230 is rotated by the driver 240 connected to a lower end thereof. The driver 240 may include a motor. When the support shaft 230 is rotated, the support plate 210 and the substrate W are rotated together. The driver 240 may vertically move the support plate 210 at any time when the substrate W is loaded or unloaded on/from the support plate 210 and when the substrate treating process (the chemical solution treating process, the rinsing process, and the drying process) or the cleaning process of the substrate support member is performed.

The treating fluid supply member 300 supplies treating fluid to the bottom surface of the substrate W or the top surface of the support plate 210 of the substrate support member 200. The treating fluid supply member 300 includes a nozzle body 302 protruding from the top surface of the support plate 210 of the substrate support member 200. The nozzle body 302 is provided with a chemical solution supply unit 310, a rinse solution supply unit 320, a drying gas supply unit 330, and a cleaning solution supply unit 340. The chemical solution supply unit 310 sprays the chemical solution onto the bottom surface of the substrate W. The rinse solution supply unit 320 sprays the rinse solution onto the bottom surface of the substrate W. The drying gas supply unit 330 sprays drying gas onto the bottom surface of the substrate W. The cleaning solution supply unit 340 sprays a cleaning solution onto the top surface of the support plate 210 of the substrate support member 200.

The chemical solution used in the substrate treating process may include at least one element selected from the group consisting of hydrofluoric acid(HF), sulfuric acid(H₂SO₄), nitric acid(HNO₃), phosphoric acid(H₃PO₄), and SC-1 solution (mixture of ammonium oxide NH₄OH, hydrogen peroxide H₂O₂, and hydrogen oxide H₂O). Deionized water (DIW) may be used as the rinse solution. Isopropyl alcohol gas may be used as the drying gas. The deionized water may be used as the cleaning solution used in the cleaning process of the substrate support member 200. The cleaning solution used in the cleaning process of the substrate support member 200 may be at room temperature. The temperature of the chemical solution used in the substrate treating process may be relatively higher than that of the cleaning solution.

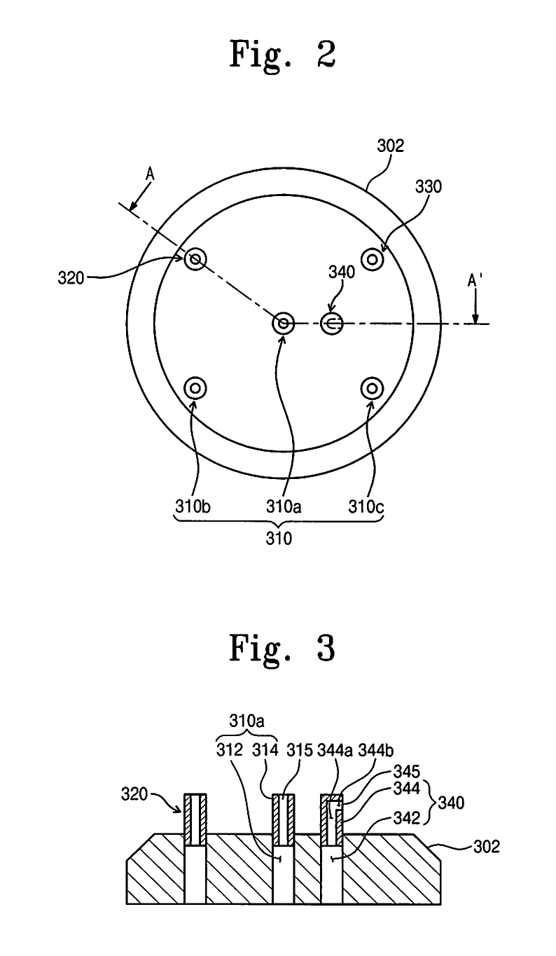

Referring to FIG. 2, the nozzle body 302 has a circular plan shape. A first chemical solution supply unit 310a is disposed on a center of a top surface of the nozzle body 302. Second and third chemical solution supply units 310b and 310c, the rinse solution supply unit 320, and the drying gas supply unit 330 are disposed on an edge portion of the top surface of the nozzle body 302 such that the second and third chemical solution supply units 310b and 310c, the rinse solution supply unit 320, and the drying gas supply unit 330 are symmetrical to each other with respect to the first chemical solution supply unit 310a. The first, second, and third chemical solution supply units 310a, 310b, and 310c may supply one of the abovementioned chemical solution to the substrate W according to a process condition. The first, second, and third chemical solution supply units 310b, 310b, and 310c, the rinse solution supply unit 320, and the drying gas supply unit 330 may have the same construction. Hence, the first chemical solution supply unit 310a will be described herein as typical example, and descriptions about the second and third chemical solution supply units 310b and 310c, the rinse solution supply unit 320, and the drying gas supply unit 330 will be omitted.

Referring to FIG. 3, the first chemical solution supply unit 310a includes a chemical solution supply line 312 and a chemical solution nozzle 314. The chemical solution supply line 312 is formed inside the nozzle body 302. The chemical solution nozzle 314 has one end inserted into the chemical solution supply line 312. The chemical solution nozzle 314 may have a tube shape. The chemical solution nozzle 314 has the other end at which a chemical solution outlet port 315 is defined. The chemical solution outlet port 315 is directed toward the bottom surface of the substrate W supported by the substrate support member 200.

The nozzle body 302 is provided with a cleaning solution supply unit 340 for spraying the cleaning solution onto the top surface of the support plate 210 of the substrate support member 200. Preferably, the cleaning solution supply unit 340 is disposed at one of positions at which the cleaning solution supply unit 340 does not interfere with the second and third chemical solution supply units 310b and 310c, the rinse solution supply unit 320, and the drying gas supply unit 330. That is, the positions denote positions at which the second and third chemical solution supply units 310b and 310c, the rinse solution supply unit 320, and the drying gas supply unit 330 are not disposed within a cleaning solution spray direction. This is for preventing the cleaning solution sprayed from the cleaning solution supply unit 340 from being introduced into nozzles of the second and third chemical solution supply units 310b and 310c, the rinse solution supply unit 320, and the drying gas supply unit 330.

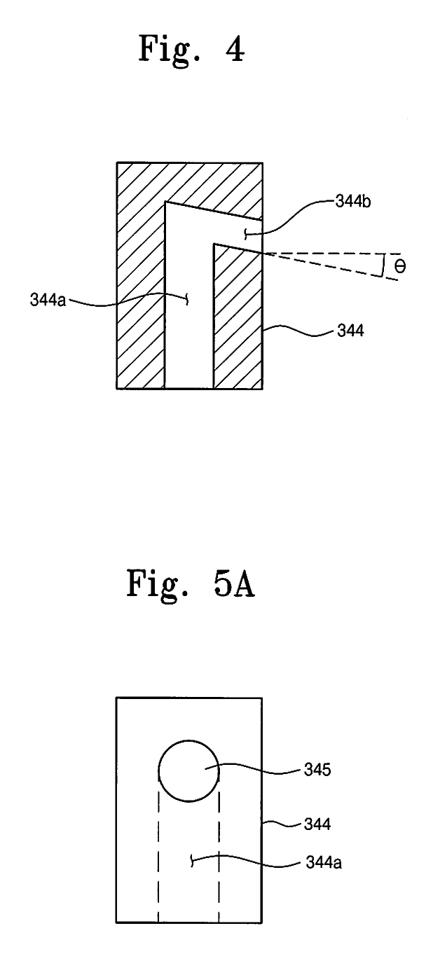

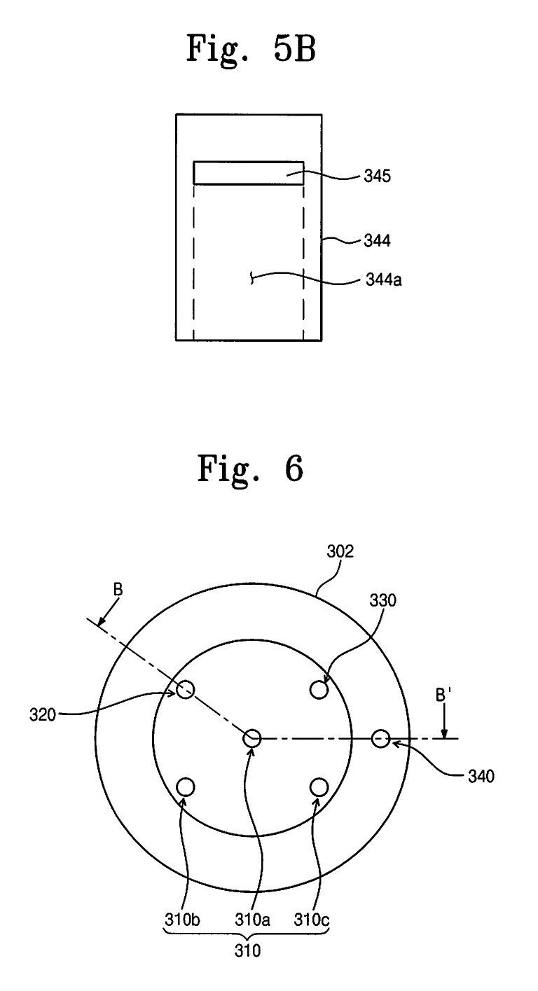

The cleaning solution supply unit 340 includes a cleaning solution supply line 342 and a cleaning solution nozzle 344. The cleaning solution supply line 342 is formed inside the nozzle body 302. The cleaning solution nozzle 344 has an end inserted into the cleaning solution supply line 342. The cleaning solution nozzle 344 may have a tube shape. The cleaning solution nozzle 344 is perpendicular to the top surface of the support plate 210 of the substrate support member 200. The cleaning solution nozzle 344 includes a first passage 344a and a second passage 344b therein. The cleaning solution flows into the first passage 344a and the second passage 344b. The first passage 344a is disposed along a longitudinal direction of the cleaning solution nozzle 344. The second passage 344b communicates with the first passage 344a and is parallel to the top surface of the support plate 210 of the substrate support member 200. Referring to FIG. 4, the second passage 344b may communicate with the first passage 344a and may be inclined downwardly toward the top surface of the support plate 210 of the substrate support member 200. The second passage 344b has an end at which a cleaning solution outlet port 345 is defined. Referring to FIGS. 5A and 5B, the cleaning solution outlet port 345 may have a hole shape or a slit shape.

Unlike the above-described construction, a chemical solution supply unit 310, a rinse solution supply unit 320, a drying gas supply unit 330, and a cleaning solution supply unit 340 may not include auxiliary nozzles in the nozzle body 302.

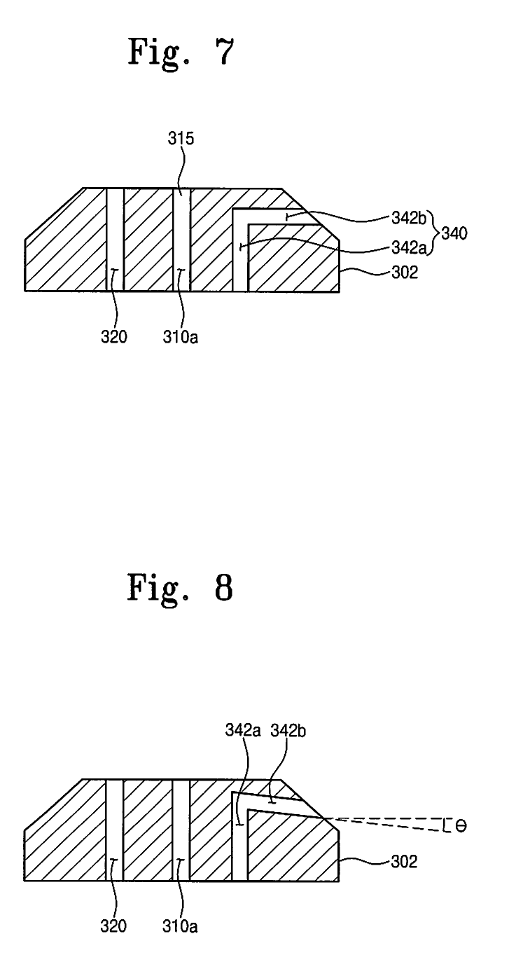

FIG. 6 is a plan view illustrating another example of a nozzle body, and FIGS. 7 and 8 are cross-sectional views taken along line B-B′ of FIG. 6. The same elements as those illustrated in FIGS. 2 and 3 are denoted by the same reference numerals, and those detailed descriptions will be omitted.

Referring to FIGS. 6 and 7, a first chemical solution supply unit 310a may be provided with a chemical solution supply line formed inside a nozzle body 302. The chemical solution supply line has an end at which a chemical solution outlet port 315 is defined. The chemical solution outlet port 315 is directed toward a bottom surface of a substrate W. Second and third chemical solution supply units 310b and 310c, a rinse solution supply unit 320, and a drying gas supply unit 330 may have the same construction as the first chemical solution supply unit 310a. Thus, those detailed descriptions are omitted.

A cleaning solution supply unit 340 may be provided with a first passage 342a and a second passage 342b, which are formed inside the nozzle body 302. The first passage 342a is perpendicular to a top surface of a support plate 210 of a substrate support member 200. The second passage 342b communicates with the first passage 342a and is parallel to the top surface of the support plate 210 of the substrate support member 200. Referring to FIG. 8, the second passage 342b may communicate with the first passage 342a and may be inclined downwardly toward the top surface of the support plate 210 of the substrate support member 200.

Referring to FIG. 1, a chemical solution supply source 317 is connected to the chemical solution supply unit 310 having the above-described construction through a chemical solution line 316. A pump 318a for adjusting a chemical solution supply pressure and a valve 318b for adjusting a chemical solution supply flow rate are disposed at the chemical solution line 316. A heater 319 for heating the chemical solution supplied from the chemical solution supply source 317 at a predetermined process temperature is disposed at the chemical solution line 316. A rinse solution supply source 327 is connected to the rinse solution supply unit 320 through a rinse solution line 326. A pump 328a and a valve 328b are disposed at the rinse solution line 326. A drying gas supply source 337 is connected to the drying gas supply unit 330 through a drying gas supply line 336. A pump 338a and a valve 338b are disposed at the drying gas supply line 336. A cleaning solution supply source 347 is connected to the cleaning solution supply unit 340 through a cleaning solution line 346. A pump 348a and a valve 348b are disposed at the cleaning solution line 346.

The collection member 400 collects the treating solution sprayed onto the substrate W or the substrate support member 200 during the substrate treating process or the cleaning process of the substrate support member 200. The collection member includes a first collection container 410, a second collection container 420, and a third collection container 430. The first collection container 410 collects the rinse solution or the cleaning solution during the rinsing process of the substrate W or the cleaning process of the substrate support member 200. The second collection container 420 and the third collection container 430 collect the chemical solution during the chemical solution treating process of the substrate W. The first, second, and the third collection containers 410, 420, and 430 disposed inside the housing 100 have a ring shape. Entrance ports 411, 421, 431 for receiving the treating solution are vertically stacked. The first, second, and third collection containers 410, 420, and 430 include bodies 412, 422, and 432 for providing a receiving space of the collected treating solution, respectively. A collection plate 434 is disposed at an end of the body 432 of the third collection container 430. The collection plate 434 extends inclinedly and upwardly from the end of the body 432 to a lower region of the support plate 210 of the substrate support member 200. When the substrate support member 200 is positioned at a process position as illustrated in FIG. 1, an end 434a of the collection plate 434 is inserted into an insert groove 212 disposed in a lower portion of the support plate 210 of the substrate support member 200 during the chemical solution treating process of the substrate W. The chemical solution flowing along a surface of the support plate 210 of the substrate support member 200 moves along the inclined collection plate 434 to flow into the body 432 when the chemical solution treating process of the substrate W is performed while the collection plate 434 is inserted into the insert groove 212.

A first collection line 440 is disposed in the first collection container 410, and a second collection line 450 is disposed in the second and third collection containers 420 and 430. Valves 442 and 452 are disposed at the first and second collection lines 440 and 450, respectively. The rinse solution or the cleaning solution introduced into the first collection container 410 during the rinsing process of the substrate W or the cleaning process of the substrate support member 200 returns to a treating solution recycling unit (not shown) through the first collection line 440. The chemical solution introduced into the second and third collection containers 420 and 430 during the chemical solution treating process of the substrate W returns to a treating solution recycling unit (not shown) through the second collection line 450. The treating solution recycling units adjust temperature and concentration of the used treating solution and filter the pollution materials to recycle the treating solution.

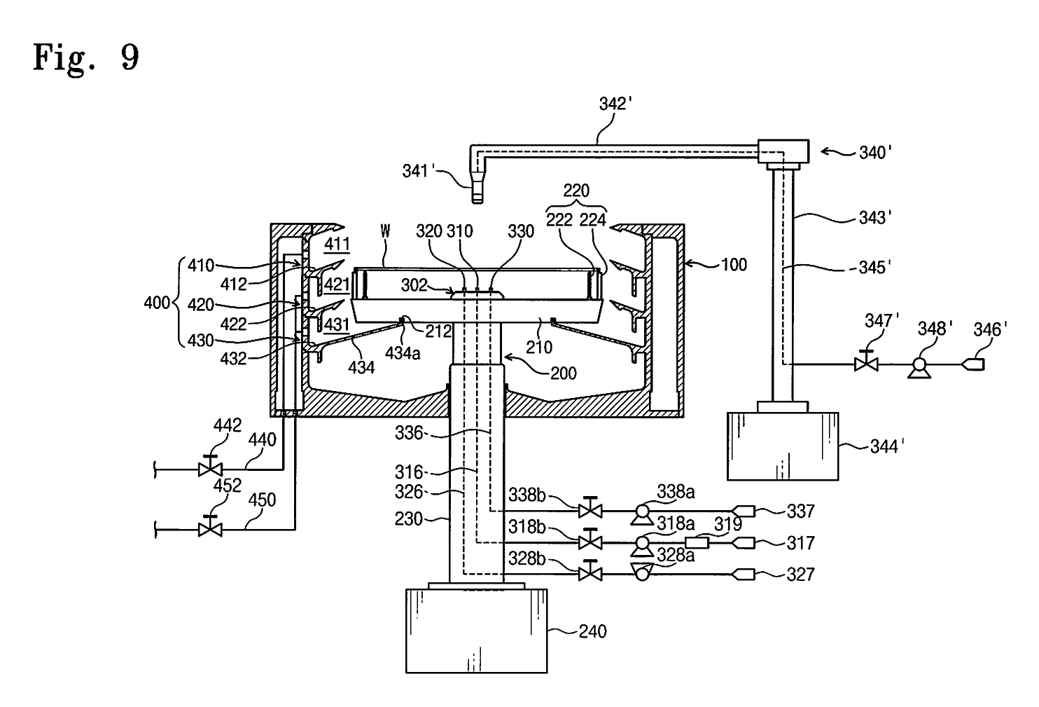

FIG. 9 is a view illustrating another example of a single type substrate treating apparatus according to the present invention. A cleaning solution supply unit (reference numeral 340 of FIG. 1) for supplying a cleaning solution to a substrate support member 200 may be disposed in a nozzle body 302 disposed on the substrate support member 200. Alternatively, the cleaning solution supply unit may be disposed at a side of the substrate support member 200.

A cleaning solution supply unit 340′ disposed at a side of the substrate support member 200 will now be described with reference to FIG. 9.

The cleaning solution supply unit 340′ is vertically disposed and includes a nozzle 341′ supplying a cleaning solution toward a substrate support member 200. The nozzle 341′ has one end connected to a nozzle support 342′. The nozzle support 342′ is disposed in a parallel direction such that the nozzle support 342′ is perpendicular to the nozzle 341′. The nozzle support 342′ has the other end coupled to a moving rod 343′. The moving rod 343′ is disposed in a vertical direction such that the moving rod 343′ is perpendicular to the nozzle support 342′. The moving rod 343′ moves the nozzle 341′ during or before and after the process. The moving rod 343′ is connected to a driver 344′. The driver 344′ for moving the moving rod 343′ may be a motor for rotating the nozzle 341′ and may be an assembly for selectively and straightly moving the nozzle 341′ in a vertical direction. The nozzle 341′ is connected to a cleaning solution supply source 346′ through a cleaning solution line 345′ provided inside the nozzle support 342′ and the moving rod 343′. A valve 347′ and a pump 348′ are disposed at the cleaning solution line 345′.

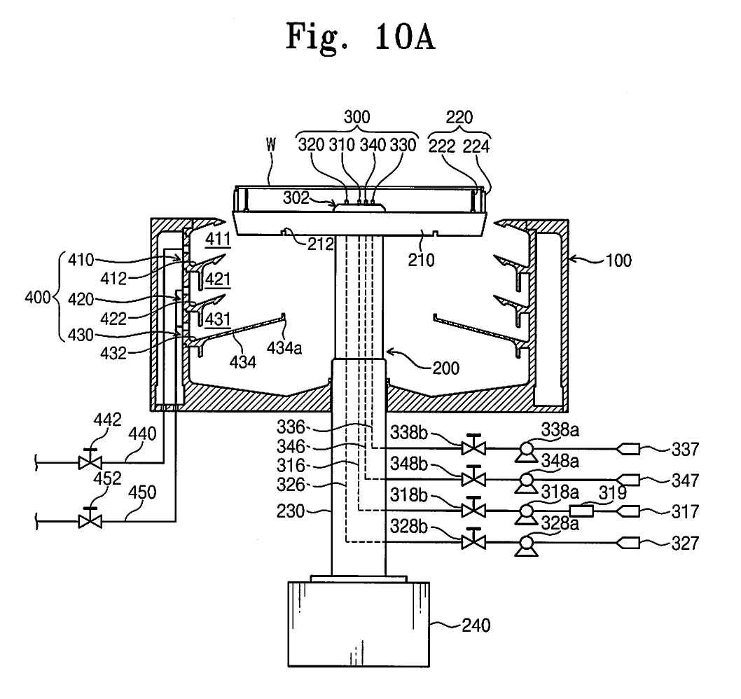

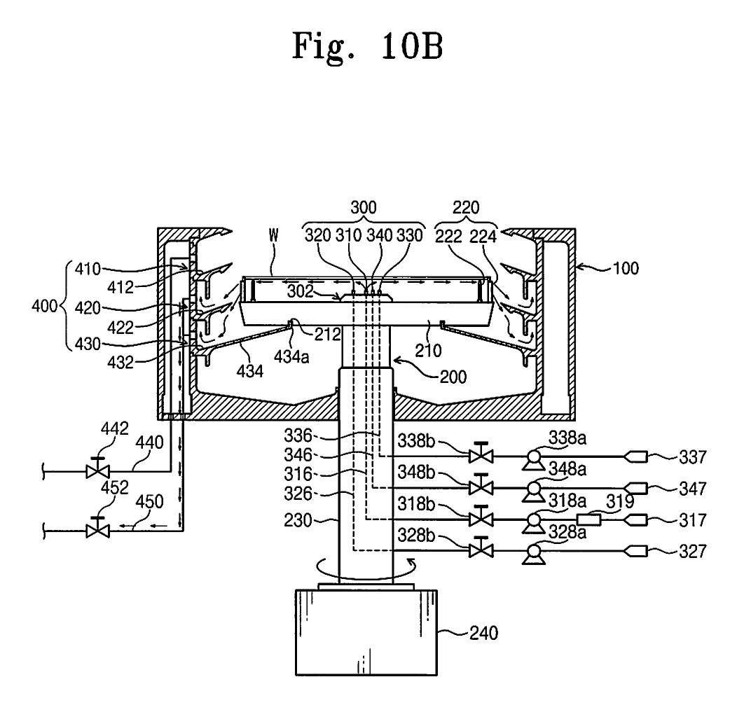

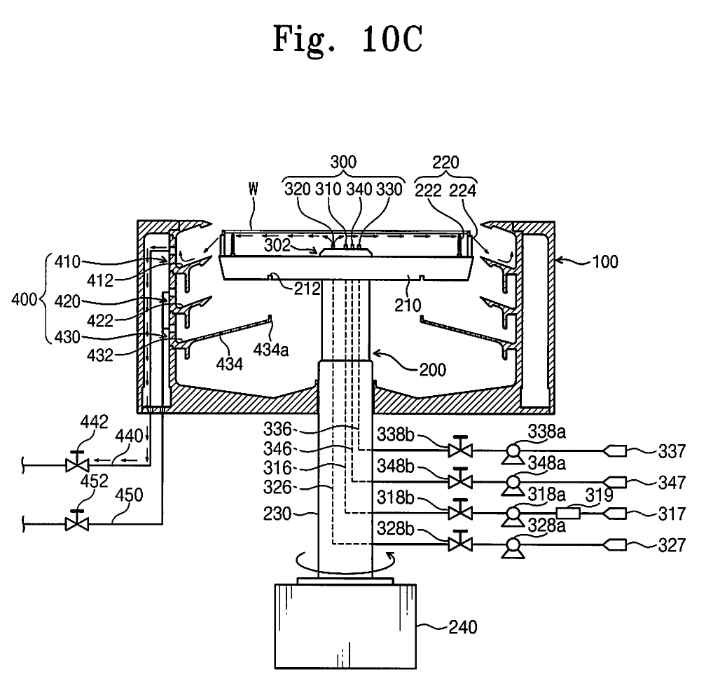

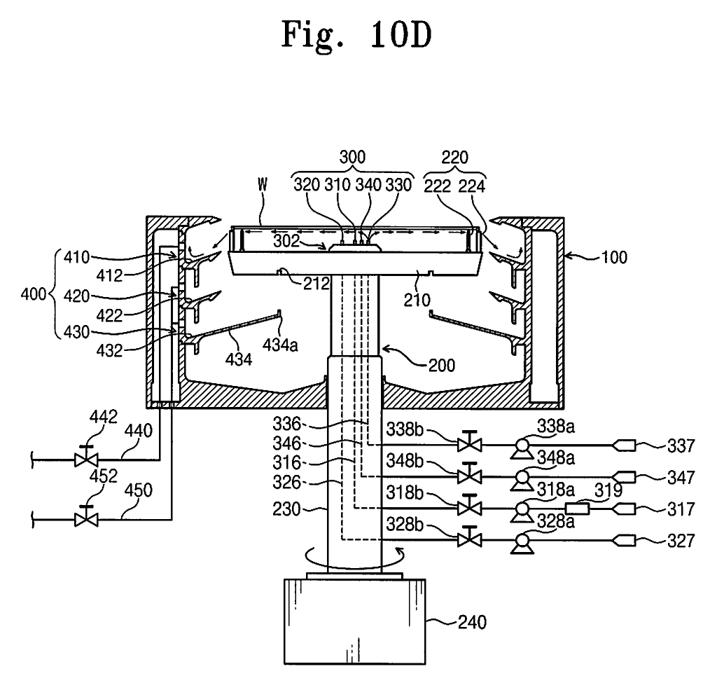

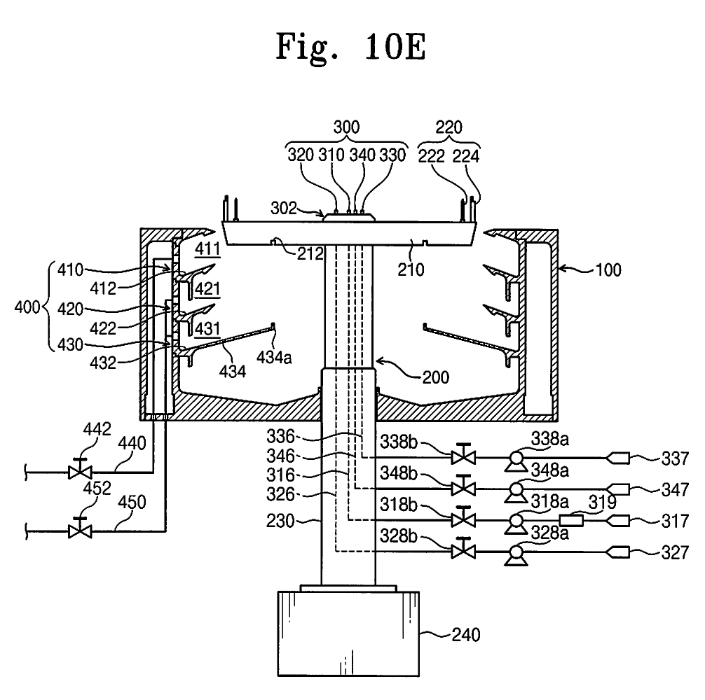

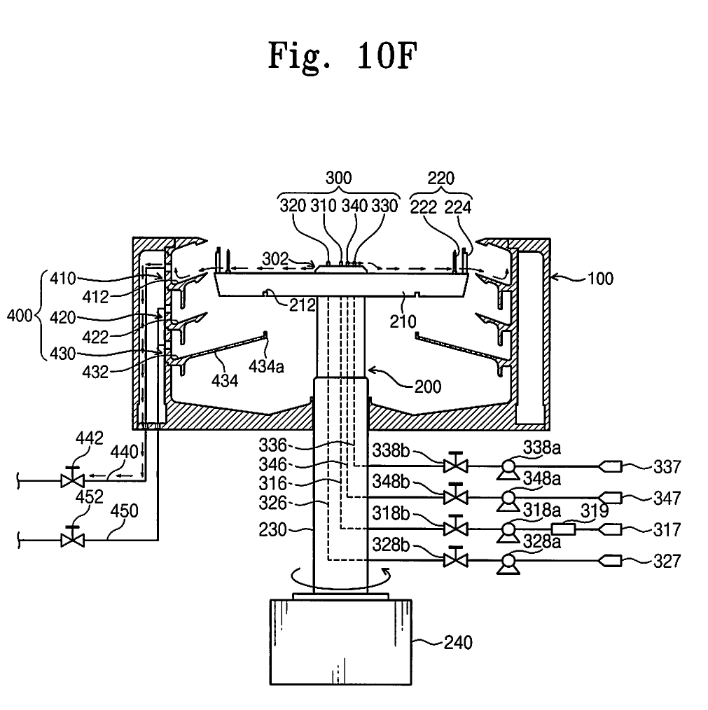

A process of treating a substrate using a single type substrate treating apparatus having the above-described construction will now be described below. FIGS. 10A through 10F are views illustrating an operation of a single type substrate treating apparatus according to the present invention.

A substrate W is loaded on a substrate support member 200. The substrate support member 200 is moved into a loading position by a driver 240. The substrate W is positioned on support pins 222 disposed on the substrate support member 200 and chucked by chucking pins 224. (See FIG. 10A)

The substrate support member 200 with loaded substrate W is moved into a chemical solution treating process position by the driver 240. The driver 240 rotates the substrate support member 200. As a result, the substrate W supported by the substrate support member 200 is rotated together. A chemical solution supply unit 310 supplies a chemical solution to a central portion of a bottom surface of the rotating substrate W. The chemical solution may be supplied by chemical solution supply units including one of the first through third chemical solution supply units or combinations thereof. SC-1 solution which is a mixture of NH₄OH, H₂O₂, and H₂O may be used as the chemical solution. The chemical solution is heated at a predetermined temperature by a heater 319 disposed at a chemical solution line 316.

The chemical solution etches or separates contaminants remaining on the bottom surface of the substrate W while the chemical solution is moved along the bottom surface of the substrate W to the periphery region due to a centrifugal force of the rotating substrate W. A portion of the used chemical solution is dispersed from the substrate W due to the centrifugal force of the rotating substrate W and is collected into a second collection container 420. A portion of the used chemical solution in which is not collected into the second collection container 420 is collected into a third collection container 430. That is, a portion of the used chemical solution in which is not collected into the second collection container 420 to flow into a space between the substrate support member 200 and the second collection container 420 flows along a collection plate 434 and is collected into a third collection container 430. The chemical solution collected into the second collection container 420 and the third collection container 430 returns to a treating solution recycling unit (not shown) through a second collection line 450. (See FIG. 10B)

When the chemical treating process is completed on the bottom surface of the substrate W, a rinsing process for removing the etched or separated contaminants remaining on the substrate W and the chemical solution is performed. The substrate support member 200 is moved into a rinsing process position by the driver 240. The driver 240 rotates the substrate support member 200. As a result, the substrate W supported by the substrate support member 200 is rotated. A rinse solution supply unit 320 supplies a rinse solution to the central portion of a bottom surface of the rotating substrate W. The rinse solution removes the etched or separated contaminants remaining on the bottom surface of the substrate W and the chemical solution while the rinse solution is moved along the bottom surface of the substrate W to the periphery region due to the centrifugal force of the rotating substrate W. A portion of the used rinse solution is dispersed from the substrate W due to the centrifugal force of the rotating substrate W and is collected into a first collection container 410. The rinse solution collected into the first collection container 410 returns to a treating solution recycling unit (not shown) through a first collection line 440. (See FIG. 10C)

When the rinsing process is completed on the bottom surface of the substrate W, a drying process for removing the rinse solution and drying the substrate W is performed. The substrate support member 200 is moved into a drying process position by the driver 240. The driver 240 rotates the substrate support member 200. As a result, the substrate W supported by the substrate support member 200 is rotated. A drying gas supply unit 330 supplies drying gas to the central portion of a bottom surface of the rotating substrate W. The drying gas removes the rinse solution remaining on the bottom surface of the substrate W and dries the substrate W while the drying gas is moved along the bottom surface of the substrate W to the periphery region due to the centrifugal force of the rotating substrate W. (See FIG. 10D)

When the chemical solution treating process, the rinsing process, and the drying process are completed on the bottom surface of the substrate W, the substrate support member 200 is moved into an unloading position by the driver 240. The substrate W supported by the substrate support member 200 is unloaded from chucking pins 224 and is moved in an equipment (not shown) in which a subsequent process is performed. (See FIG. 10E)

The chemical solution treating process, the rinsing process, and the drying process as described above are repeatedly performed on the plurality of substrates W provided to the substrate treating apparatus 10. When the processes are performed, the pollution materials such as the remaining chemical solution and the fume produced from the chemical solution may be generated on the substrate support member 200. The pollution materials on the substrate support member 200 must be periodically removed after a series of substrate treating processes is repeatedly performed. The cleaning process for removing the pollution materials on the substrate support member 200 using a single type substrate treating apparatus 10 according to the present invention will be described below.

The substrate support member 200 is moved into a cleaning process position by the driver 240 after a series of substrate treating processes is performed in the single type substrate treating apparatus 10. The cleaning process position may have the same position as the rinsing process position or the chemical solution treating process position on the bottom surface of the substrate W. The driver 240 rotates the substrate support member 200, and thus the substrate W supported by the substrate support member 200 is rotated.

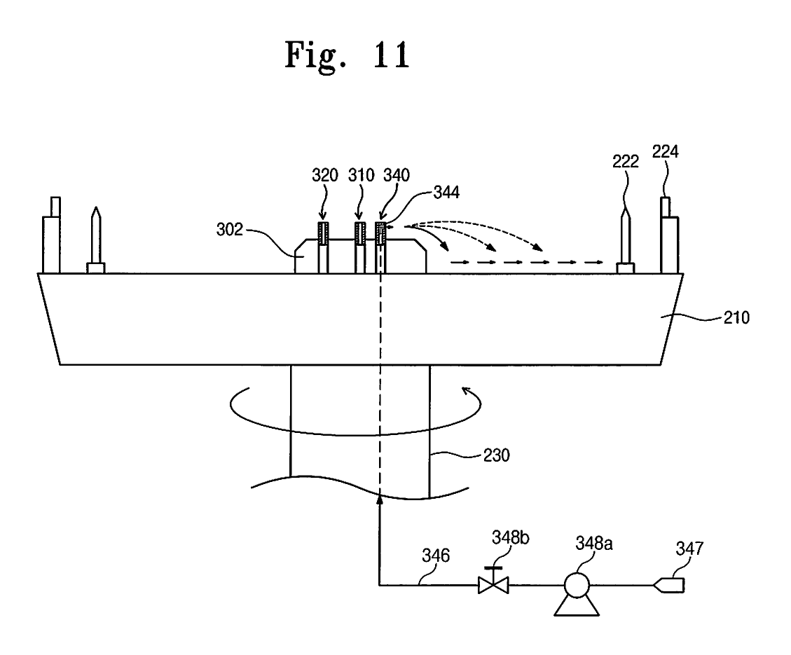

The cleaning solution supply unit 340 supplies the cleaning solution toward the rotating substrate support member 200. Referring to FIG. 11, a position at which the cleaning solution is supplied to the substrate support member 200 is adjusted by a pump 348a disposed at a cleaning solution line 346. As a pressure of the chemical solution supplied from the pump 348a increases, the cleaning solution is supplied further away along a radial direction of the substrate support member 200 toward the outside. Deionized water (DIW) may be used as the cleaning solution. The cleaning solution removes the pollution materials remaining on the substrate support member 200 while the cleaning solution is moved along a top surface of the substrate support member 200 to a periphery region due to a centrifugal force of the substrate support member 200. Since the cleaning solution is supplied at room temperature, thermal deformation of the substrate support member 200 due to the high temperature chemical solution may be prevented. As the substrate treating process using the high temperature chemical solution is repeatedly performed in the substrate treating apparatus 10, the substrate support member 200 may be thermal-deformed due to the high temperature chemical solution dropping from the substrate W to the substrate support member 200. The thermal deformation of the substrate support member 200 may be minimized by cleaning the substrate support member 200 using the room temperature cleaning solution after a series of repeated substrate treating processes is performed. The used cleaning solution is dispersed from the substrate support member 200 due to the centrifugal force of the rotating substrate support member 200 and is introduced into the first collection container 410. The cleaning solution introduced into the first collection container 410 returns to a treating solution recycling unit (not shown) through a first collection line 440. (See FIG. 10F)

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A single type substrate treating apparatus comprising:
a substrate support member supporting a substrate; and
a cleaning solution supply unit spraying a cleaning solution onto the substrate support member so as to remove contaminants remaining on the substrate support member.

2. The single type substrate treating apparatus of claim 1, wherein the cleaning solution supply unit is disposed in a nozzle body disposed on the substrate support member and comprises a nozzle having an end inserted into a cleaning solution supply line formed inside the nozzle body and spraying the cleaning solution onto the substrate support member.

3. The single type substrate treating apparatus of claim 2, further comprising a rotation driver rotating the substrate support member.

4. A single type substrate treating apparatus comprising:
a rotatable substrate,support member supporting a substrate which is spaced upwardly from the substrate support member;
a chemical solution supply unit spraying a chemical solution onto a bottom surface of the substrate; and
a cleaning solution supply unit spraying a cleaning solution onto the substrate support member so as to remove the chemical solution remaining on the substrate support member after a substrate treating process using the chemical solution is performed.

5. The single type substrate treating apparatus of claim 4, wherein the chemical solution supply unit and the cleaning solution supply unit are disposed in a nozzle body disposed on the substrate support member.

6. The single type substrate treating apparatus of claim 5, wherein the cleaning solution supply unit comprises a nozzle having an end inserted into a cleaning solution supply line formed inside the nozzle body and spraying the cleaning solution onto the substrate support member.

7. The single type substrate treating apparatus of claim 6, wherein the nozzle is perpendicular to a top surface of the substrate support member, and a first passage and a second passage are formed in the nozzle, the first passage being disposed along a longitudinal direction of the nozzle, and the second passage communicating the first passage and being parallel to the top surface of the substrate support member.

8. The single type substrate treating apparatus of claim 6, wherein the nozzle is perpendicular to a top surface of the substrate support member, and a first passage and a second passage are formed in the nozzle, the first passage being disposed along a longitudinal direction of the nozzle, and the second passage communicating the first passage and being inclined downwardly toward the top surface of the substrate support member.

9. The single type substrate treating apparatus of claim 5, wherein the cleaning solution supply unit is provided with a first passage and a second passage which are formed inside the nozzle body, the first passage being perpendicular to the top surface of the substrate support member, and the second passage communicating the first passage and being parallel to the top surface of the substrate support member.

10. The single type substrate treating apparatus of claim 5, wherein the cleaning solution supply unit is provided with a first passage and a second passage which are formed inside the nozzle body, the first passage being perpendicular to the top surface of the substrate support member, and the second passage communicating the first passage and being inclined downwardly toward the top surface of the substrate support member.

11. The single type substrate treating apparatus of claim 7, wherein the second passage has an end at which a chemical solution outlet port having a hole shape is defined.

12. The single type substrate treating apparatus of claim 7, wherein the second passage has an end at which a chemical solution outlet port having a slit shape is defined.

13. The single type substrate treating apparatus of claim 4, further comprising:
a chemical solution supply line supplying the chemical solution to the chemical solution supply unit; and
a heater disposed at the chemical solution supply line and heating the chemical solution supplied from the chemical solution supply unit at a process temperature.

14. The single type substrate treating apparatus of claim 13, wherein the cleaning solution comprises room temperature deionized water.

15. A cleaning method of a substrate treating apparatus, the cleaning method comprising:
spraying a chemical solution onto a bottom surface of a substrate supported and spaced upwardly by/from a substrate support member to treat the substrate; and
spraying a cleaning solution onto a top surface of the substrate support member to remove the chemical solution remaining on the substrate support member.

16. The cleaning method of claim 15, wherein the substrate support member is rotated.

17. The cleaning method of claim 15, wherein a temperature of the chemical solution is relatively higher than that of the cleaning solution.

18. The cleaning method of claim 17, wherein the chemical solution comprises a mixture of ammonium hydroxide NH₄OH, hydrogen peroxide H₂O₂, and hydrogen oxide H₂O.

19. The cleaning method of claim 17, wherein the cleaning solution comprises room temperature deionized water.

20. The cleaning method of claim 15, wherein the chemical solution remaining on the substrate support member is removed after a series of chemical solution treating processes is sequentially performed on a plurality of substrates.
